(19) United States
(12) Patent Application Publication
(10) Pub. No.: US 2015/0071730 A1
(43) Pub. Date: Mar. 12, 2015

(54) FLOATING FASTENER

(71) Applicant: HANWIT PRECISION INDUSTRIES LTD., New Taipei City (TW)

(72) Inventor: Ying-Chih TSENG, New Taipei City (TW)

(73) Assignee: HANWIT PRECISION INDUSTRIES LTD., New Taipei City (TW)

(21) Appl. No.: 14/025,723

(22) Filed: Sep. 12, 2013

(51) Int. Cl. F16B 39/10; F16B 5/02

(52) U.S. Cl. CPC F16B 39/101; F16B 5/0266
USPC 411/318

(57) ABSTRACT

A floating fastener includes a mounting base member affixed to a first panel member and including an upper locating flange and a lower locating flange disposed at different elevations around the periphery, a rotary fastening member supported on an elastic member in the mounting base member for locking a second panel member to the first panel member through a rotary motion, and a cap member affixed to the head of the rotary fastening member and axially slidably coupled to the mounting base member between the upper and lower locating flanges of the mounting base member and elastically deformably movable over the lower locating flange and stoppable at a bottom side of the lower locating flange when fastening the rotary fastening member to the second panel member to lock the first and second panel member together.

### BACKGROUND OF THE INVENTION

1. Field of the Invention

The present invention relates to fastener means for detachably securing two panel members together, and more particularly to a floating fastener consisting of a mounting base member, a rotary fastening member, an elastic member and a cap member, which facilitates mounting and dismounting between two panel members with less effort.

2. Description of the Related Art

When joining panel members, a fastening device formed of a lock screw, a rotary knob and a washer may be used. During application, the lock screw, rotary knob and washer of each fastening device are assembled and then mounted at a first panel member. When fastening the first panel member to a second panel member, rotate the rotary knob of each fastening device to drive the respective lock screw into a respective mounting screw hole at the second panel member, and then use a hand tool to fasten tight the lock screw. These fastening devices are widely used in server racks for telecommunication, industrial computers, machine tools, and other situations where multiple panel members are to be fastened in a stack.

Further, a floating fastener, formed of a cap member, a rotary fastening member, a spring member and a socket member, has also been created for detachably fastening two panel members together by: affixing the socket member of the floating fastener to a mounting through hole of one panel member and then threading the spring-loaded screw member into a mounting screw hole of the other panel member. After separation between the two panel members, the floating fastener is kept secured to the respective panel member. FIG. 12 illustrates a floating fastener of this design. As illustrated, this design of floating fastener comprises a socket member A, which comprises a bottom mounting flange A4 extended from the bottom side thereof and affixed to a panel member D by welding and an outside stop flange A2 extending around the periphery thereof and stopped at the top wall of the panel member D, a rotary fastening member B, which comprises a head B1 suspending above the socket member A and screw rod B2 perpendicularly downwardly extended from the center of the bottom wall of the head B1 and inserted through the socket member A, a spring member A1 mounted around the socket member A and stopped between the head B1 of the rotary fastening member B and the outside stop flange A2 of the socket member A, a stop member A3 mounted in the inside space A0 in the socket member A around a plain segment of the rotary fastening member B between the head B1 and the screw rod B2 to keep the rotary fastening member B in the socket member A, and a nut C threaded onto the screw rod B2 of the rotary fastening member B and stopped at the bottom side of the panel member D.

The floating fastener shown in FIG. 12 enables the socket member A to be positively and accurately bonded to the panel member D without causing damage to the threads of the screw rod B2 or the structure of the panel member D. However, when welding the socket member A to the panel member D, the applied solder paste can flow into tiny gaps in between the screw rod B2 and the nut C, and the nut C can get stuck. A thread damage may occur when using a tool to remove the nut C from the screw rod B2. Thus, mounting and dismounting of this design of floating fastener will take much time and labor.

FIG. 13 illustrates another prior art fastener design for detachably fastening two panel member together. This design of fastener comprises a socket member E fixedly fastened to a first panel member G, and a rotary fastening member F mounted in the socket member E and fastenable to a second panel member H to lock the second panel member H to the first panel member E. The rotary fastening member F comprises a head F1 suspending above the socket member E, a shoulder F2 stoppable below an annular top wall E1 of the socket member E, a neck F21 connected between the head F1 and the shoulder F2 and inserted through the annular top wall E1 of the socket member E, and a screw rod F3 axially forwardly extended from the shoulder F2 in a concentric manner for threading into a mounting screw hole in the second panel member H. Rotating the rotary fastening member F in the reversed direction to disengage the screw rod F3 from the second panel member H allows separation between the first panel member G and the second panel member H.

According to the design of the fastener shown in FIG. 13, the screw rod F3 is constantly kept outside the socket member E. When attaching the first panel member G to the second panel member H, it is difficult to keep the screw rod F3 in accurate alignment with the mounting screw hole in the second panel member H. Thus, an impact between the screw rod F3 and the second panel member H may occur accidentally, causing damage to the threads of the screw rod F3 or the structure of the second panel member H. An improvement in this regard is necessary.

### SUMMARY OF THE INVENTION

The present invention has been accomplished under the circumstances in view. It is therefore the main object of the present invention to provide a floating fastener for detachably fastening two panel members together, which has the advantages of ease of use, high installation reliability and high positioning accuracy.

To achieve this and other objects of the present invention, a floating fastener of the present invention comprises a mounting base member, a rotary fastening member, an elastic member, and a cap member. The mounting base member comprises a through hole vertically extending through opposing top and bottom sides thereof, a bottom mounting neck downwardly extended from the bottom side and affixed to a first panel member, and a lower locating flange extending around the periphery thereof adjacent to the bottom mounting neck. The rotary fastening member comprises a head suspending above the mounting base member, a shoulder perpendicularly downwardly extended from a flat bottom wall of the head and a screw rod axially forwardly extended from the shoulder in a concentric manner and adapted for threading into a mounting screw hole of a second panel member to detachably fasten the first panel member to the second panel member. The elastic member is mounted around the shoulder of the rotary fastening member and stopped between the flat bottom wall of the head of the rotary fastening member and a part inside the mounting base member. The cap member is affixed to the head of the rotary fastening member, comprising an accommodation open space surrounded by an inside wall thereof and extending through opposing top and bottom sides thereof for accommodating the mounting base member and the rotary fastening member, and an inside bottom stop flange extended around the inside wall of the cap member at a bottom side of the accommodation open space and axially slidably coupled to the periphery of the mounting base member and elastically deformably movable in direction from the top side of the mounting base member toward the bottom side of the mounting base member over the lower locating flange and then stoppable at a bottom side of the lower locating flange. By means of rotating the rotary fastening member in the reversed direction to disengage the screw rod from the mounting screw hole of the second panel member, the first panel member can then be directly separated from the second panel member.

Preferably, the mounting base member further comprises an upper locating flange extending around the periphery near the top side thereof. The upper locating flange defines a sloping thrust surface at a top side thereof, and a bottom abutment surface at a bottom side thereof. Further, the upper locating flange is relatively larger in diameter than the lower locating flange. Normally, the inside bottom stop flange of the cap member is axially slidably coupled to the periphery of the mounting base member between the upper locating flange and the lower locating flange, prohibiting the rotary fastening member from falling out of the mounting base member.

Further, when mounting the mounting base member of the floating fastener in the first panel member, the cap member is lowered to move the inside bottom stop flange of the cap member over the sloping guide surface of the lower locating flange of the mounting base member by force. Subject to the elastic material property of the cap member, the inside bottom stop flange of the cap member can easily downwardly be moved over the sloping guide surface of the lower locating flange and then stopped at the bottom stop surface of the lower locating flange. Thus, the mounting base member can be riveted or welded to the first panel member positively and accurately, achieving a high quality and cost-effective installation.

Further, when attaching the first panel member (for example, a face panel) to the second panel member (for example, a rack), the inside bottom stop flange of the cap member is kept axially slidably coupled to the periphery of the mounting base member between the upper locating flange and the lower locating flange. At this time, the screw rod of the rotary fastening member can be moved back to the inside of the mounting base member to prevent impact between the screw rod and the first panel member and any thread damage.

After the screw rod of the rotary fastening member is fastened to the mounting screw hole of the second panel member, the inside bottom stop flange of the cap member is moved over the sloping guide surface of the lower locating flange of the mounting base member and stopped at the bottom stop surface of the lower locating flange. Thus, the lower locating flange of the mounting base member can stop the inside bottom stop flange of the cap member to prevent backward rotation of the screw rod relative to the mounting screw hole of the second panel member, enhancing installation stability.

### BRIEF DESCRIPTION OF THE DRAWINGS

FIG. 1 is an oblique top elevational view of a floating fastener in accordance with the present invention.

FIG. 2 is an exploded view of the floating fastener in accordance with the present invention.

FIG. 3 corresponds to FIG. 2 when viewed from another angle.

FIG. 4 is a sectional side view of the floating fastener in accordance with the present invention.

FIG. 5 is a schematic installed view of the present invention, illustrating the installation of the floating fastener in a mounting through hole of a first panel member (I).

FIG. 6 is a schematic installed view of the present invention, illustrating the installation of the floating fastener in a mounting through hole of a first panel member (II).

FIG. 7 corresponds to FIG. 6, illustrating the inside bottom stop flange of the cap member coupled to the periphery of the mounting base member between the upper locating flange and lower locating flange after the mounting base member riveted to the first panel member.

FIG. 8 is a sectional side view of an alternate form of the floating fastener in accordance with the present invention.

FIG. 9 is a schematic applied view of the present invention, illustrating connection between the first panel member and the second panel member after installation of the floating fastener in the first panel member.

FIG. 10 corresponds to FIG. 9, illustrating the screw rod of the rotary fastening member of the floating fastener threaded into the mounting screw hole of the second panel member.

FIG. 11 corresponds to FIG. 10, illustrating the screw rod of the rotary fastening member of the floating fastener disengaged from the mounting screw hole of the second panel member for allowing removal of the first panel member from the second panel member.

FIG. 12 is a sectional side of a floating fastener according to the prior art.

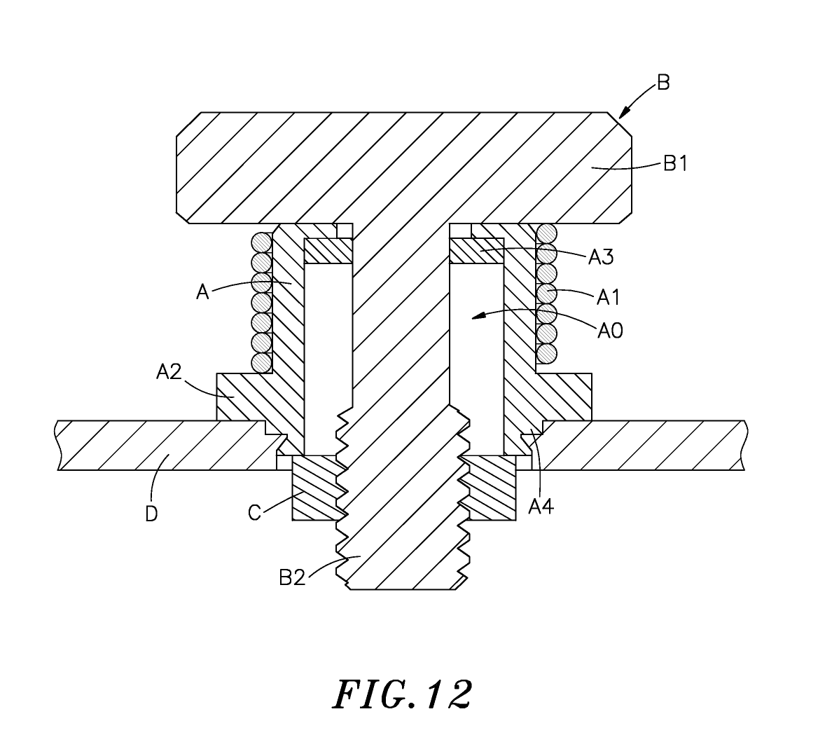

FIG. 13 illustrates another design of panel member fastener according to the prior art.

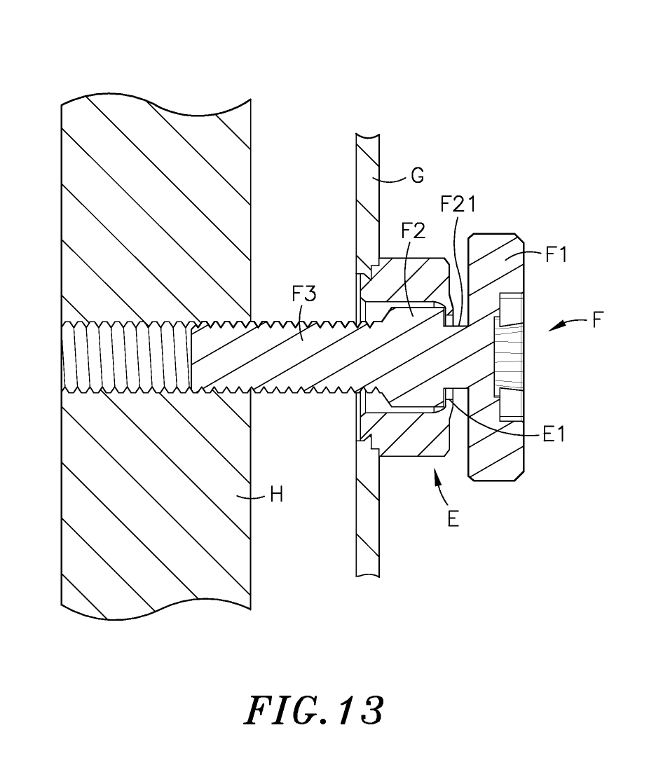

### DETAILED DESCRIPTION OF THE PREFERRED EMBODIMENT

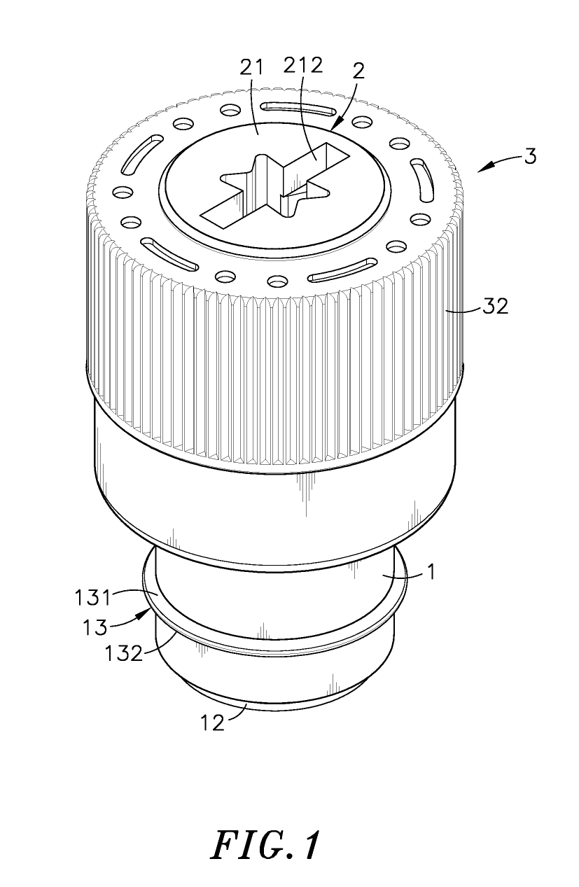

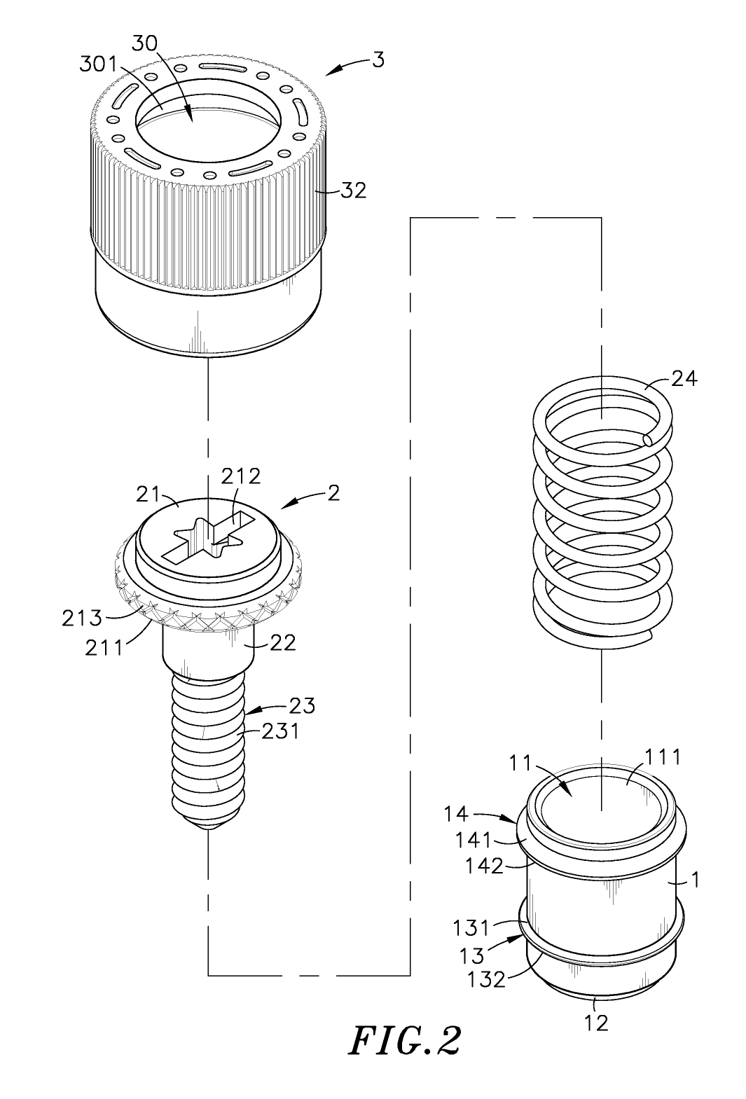

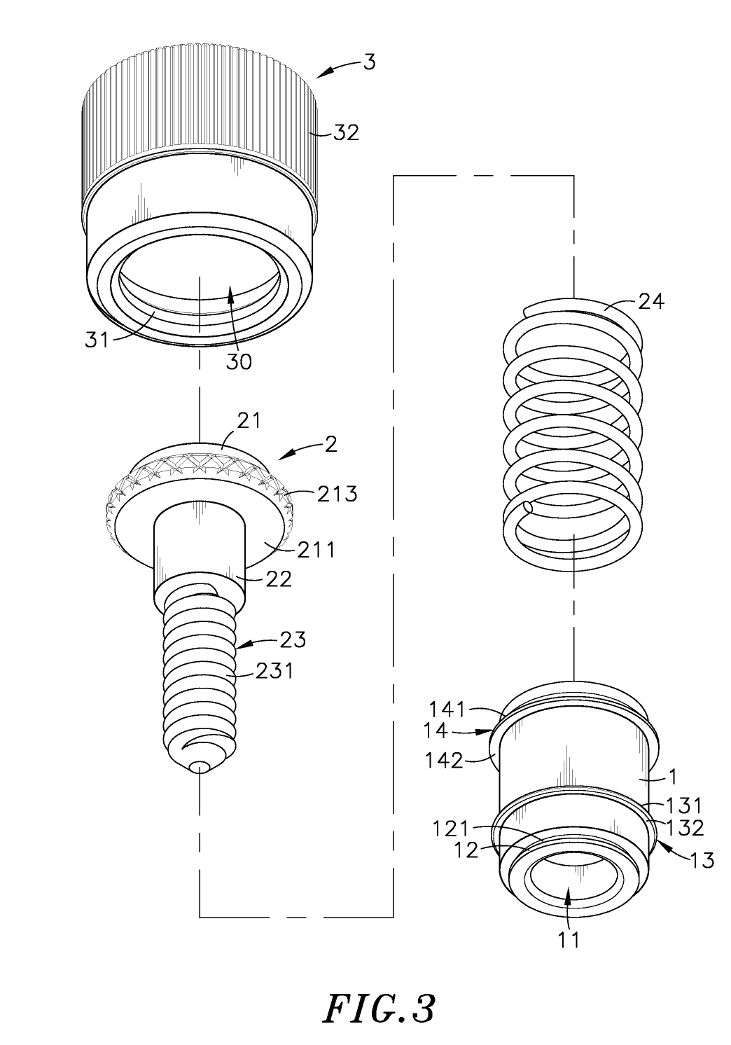

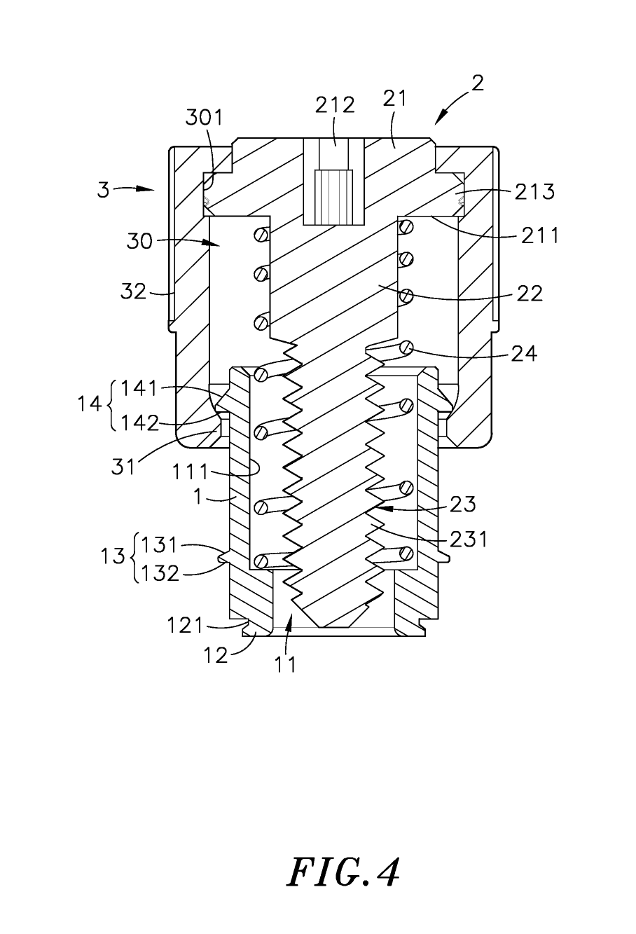

Referring to FIGS. 1-4, a floating fastener in accordance with the present invention is shown. The floating fastener comprises a mounting base member 1, a rotary fastening member 2, an elastic member, for example, compression spring 24, and a cap member 3.

The mounting base member 1 is an open-ended cylindrical member comprising a recessed accommodation chamber 111 defined in a top side thereof, a through hole 11 vertically extending through opposing top and bottom sides thereof across the recessed accommodation chamber 111, a bottom mounting neck 12 downwardly extended from the bottom side thereof around the through hole 11, a mounting groove 121 extending around the periphery of the bottom mounting neck 12, and a lower locating flange 13 and an upper locating flange 14 extending around the periphery thereof at different elevations. The lower locating flange 13 defines a sloping guide surface 131 at a top side thereof, and a bottom stop surface 132 at a bottom side thereof. The upper locating flange 14 is relatively larger in diameter than the lower locating flange 131. Further, the upper locating flange 14 defines a sloping thrust surface 141 at a top side thereof, and a bottom abutment surface 142 at a bottom side thereof.

The rotary fastening member 2 comprises a head 21 suspending above the mounting base member 1, an engagement portion 213 made in the form of an array of teeth, an embossed pattern, an array of tiny protrusions or any of a variety of other positioning designs and disposed around the periphery of the head 21, a shoulder 22 perpendicularly downwardly extended from a center area of a flat bottom wall 211 of the head 21 and inserted into the through hole 11 of the mounting base member 1, a screw rod 23 axially extended from a bottom end of the shoulder 22 opposite to the head 21 in a concentric manner and defining a spiral outer thread 231 around the periphery thereof, and a tool-positioning means 212 formed in an opposing top wall of the head 21 for the positioning of a hand tool for rotating the rotary fastening member 2. The tool-positioning means 212 can be made in the form of a straight slot, crossed slot, star shaped slot or hexagonal slot, or in the form of a straight block, crossed block, star shaped block or hexagonal block.

The compression spring 24 is mounted around the shoulder 22 and screw rod 23 of the rotary fastening member 2, and stopped between the bottom wall 211 of the head 21 of the rotary fastening member 2 and the recessed accommodation chamber 111 of the mounting base member 1.

The cap member 3 comprises an accommodation open space 30 surrounded by an inside wall thereof and extending through opposing top and bottom sides thereof, an inside locating groove 301 extending around the inside wall near the top side for engagement with the engagement portion 213 of the rotary fastening member 2, an inside bottom stop flange 31 extended around the inside wall at a bottom side of the accommodation open space 30, and a grip 32 extending around the periphery thereof and made in the form of a series of longitudinal teeth, an embossed pattern, an array of raised portions, or any anti-slip design. Preferably, the cap member 3 is directly molded on the head 21 of the rotary fastening member 2 by insert molding.

When assembling the floating fastener, sleeve the compression spring 24 onto the shoulder 22 of the rotary fastening member 2 after the cap member 3 is molded on or fastened to the head 21 of the rotary fastening member 2, and then insert the screw rod 23 and shoulder 22 of the rotary fastening member 2 into the through hole 11 of the mounting base member 1 to let the compression spring 24 be stopped between the bottom wall of the recessed accommodation chamber 111 and the flat bottom wall 211 of the head 21 of the rotary fastening member 2, and then lower the cap member 3 to move the inside bottom stop flange 31 of the cap member 3 over the sloping thrust surface 141 of the upper locating flange 14 of the mounting base member 1 by force. Subject to the elastic material property of the cap member 3, the inside bottom stop flange 31 of the cap member 3 can easily downwardly be moved over the sloping thrust surface 141 of the upper locating flange 14 of the mounting base member 1. After the inside bottom stop flange 31 is moved over the sloping thrust surface 141 of the upper locating flange 14 and the applied downward pressure is disappeared, the elastic potential energy of the compression spring 24 immediately pushes the rotary fastening member 2 and the cap member 3 upwards, causing the inside bottom stop flange 31 of the cap member 3 to be stopped against the bottom abutment surface 142 of the upper locating flange 14 of the mounting base member 1, and thus, the rotary fastening member 2 is prohibited from escaping out of the mounting base member 1. Thus, the mounting base member 1, the rotary fastening member 2 and the cap member 3 are assembled, forming the desired floating fastener.

Further, in this preferred embodiment, the mounting base member 1 and the rotary fastening member 2 are metal members of one-piece design. Further, the cap member 3 can be directly molded on the head 21 of the rotary fastening member 2 by insert molding. Alternatively, the rotary fastening member 2 and the cap member 3 can be separately made and then fastened together by forcing the engagement portion 213 of the rotary fastening member 2 into friction engagement with the inside locating groove 301 of the cap member 3. Further, in this preferred embodiment, the inside bottom stop flange 31 of the cap member 3 is stopped against the bottom abutment surface 142 of the upper locating flange 14 of the mounting base member 1 to prohibit the rotary fastening member 2 from escaping out of the mounting base member 1. However, this design of preventing the rotary fastening member 2 from escaping out of the mounting base member 1 is not a limitation. C-shaped retainer, ring cushion or any other stoppage device can be used and mounted between the mounting base member 1 and the rotary fastening member 2, allowing the rotary fastening member 2 to move axially relative to the mounting base member 1 and prohibiting the rotary fastening member 2 from falling out of the mounting base member 1.

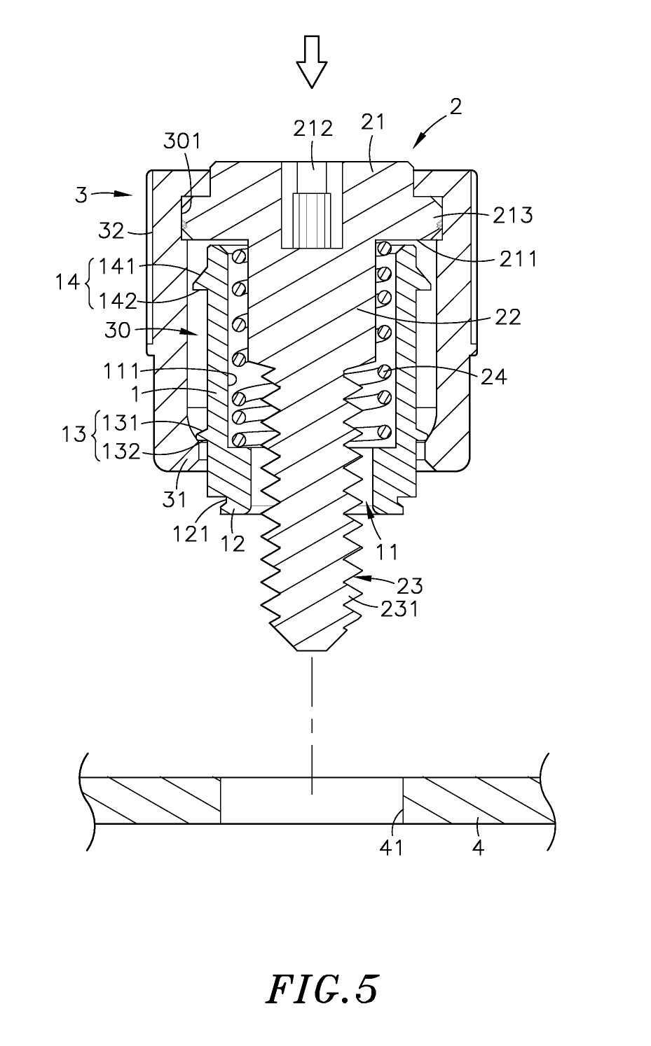

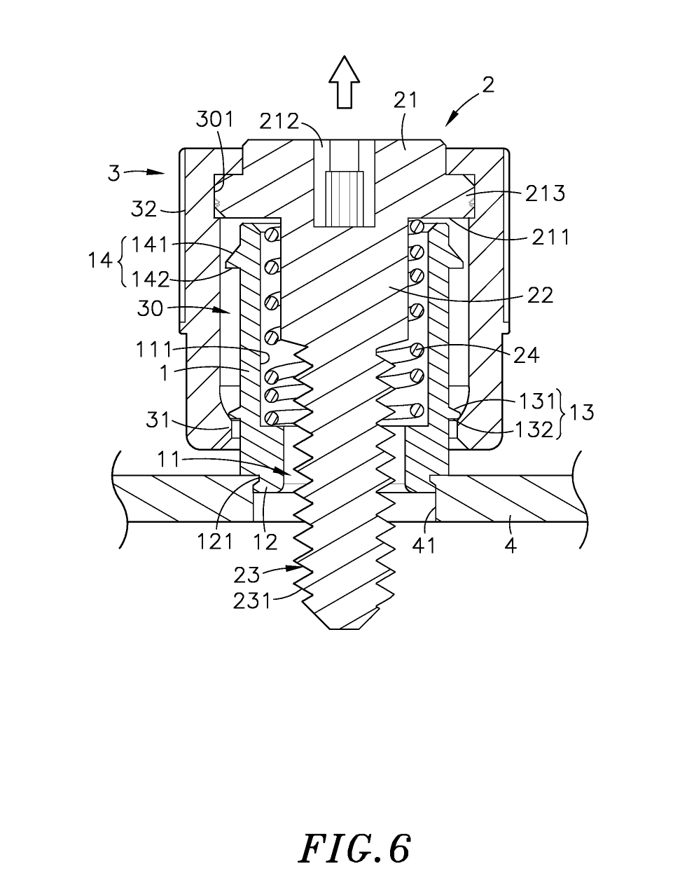

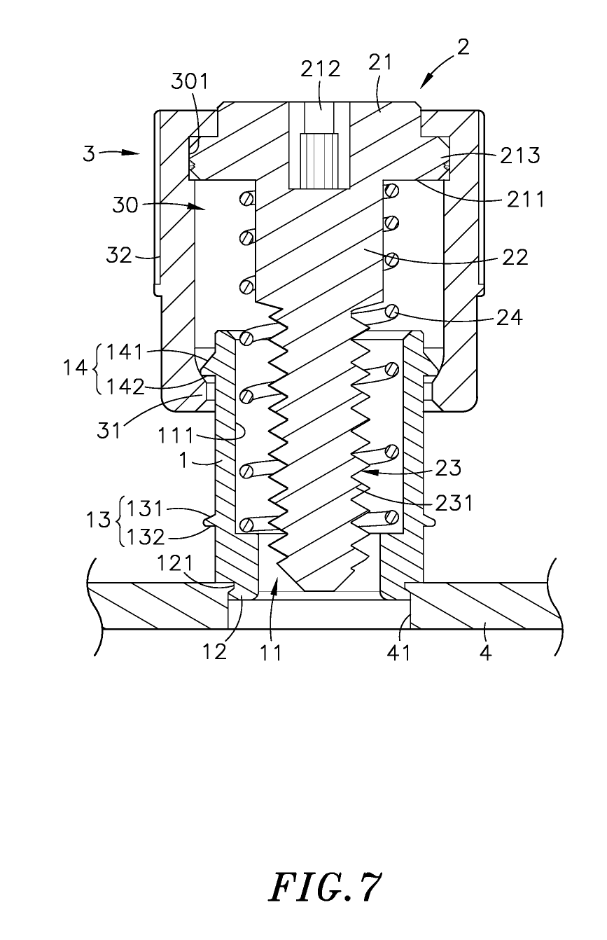

Referring to FIGS. 5-7, the floating fastener can be used in a telecommunication server rack, computer server, machine tool, board set structure, cabinet or keyboard rack, or other situations where multiple panel members are to be fastened in a stack. For example, the floating fastener can be installed in a first panel member 4 in a server case to detachably fasten a second panel member 5 to the first panel member 4, wherein the server case houses a motherboard, power supply device, data access equipment (hard disk drive, CD-ROM player, etc.), interface cards and/or other electronic devices.

When installing the floating fastener in the first panel member 4, lower the cap member 3 to move the inside bottom stop flange 31 of the cap member 3 over the sloping guide surface 131 of the lower locating flange 13 of the mounting base member 1 by force. Subject to the elastic material property of the cap member 3, the inside bottom stop flange 31 of the cap member 3 can easily downwardly be moved over the sloping guide surface 131 of the lower locating flange 13. After the inside bottom stop flange 31 is moved over the sloping guide surface 131 of the lower locating flange 13 and the applied downward pressure is disappeared, the elastic potential energy of the compression spring 24 immediately pushes the rotary fastening member 2 and the cap member 3 upwards relative to the mounting base member 1, causing the inside bottom stop flange 31 of the cap member 3 to be stopped against the bottom stop surface 132 of the lower locating flange 13. At this time, the cap member 3 is axially slidably secured to the mounting base member 1. Thereafter, a vacuum suction type pickup device (not shown) can be operated to pick up the head 21 of the rotary fastening member 2 of the floating fastener and then to position the mounting base member 1 in the mounting through hole 41 of the first panel member 4, enabling the mounting base member 1 to be riveted or welded to the first panel member 4 positively and accurately. Thus, a high quality and cost-effective installation can be achieved.

During operation of the vacuum suction type pickup device to pick up the floating fastener, the pickup head of the vacuum suction type pickup device is attached to the head 21 of the rotary fastening member 2 that is exposed to the outside of the cap member 3, and then the vacuum suction type pickup device is controlled to position the mounting base member 1 of the floating fastener in the mounting through hole 41 of the first panel member 4, thereafter, a stamping tool (not shown) is operated to stamp on the head 21 of the rotary fastening member 2 against the mounting base member 1, forcing the mounting groove 121 of the bottom mounting neck 12 into engagement with the peripheral edge of the mounting through hole 41 of the first panel member 4 tightly. Thus, the mounting base member 1 is affixed to the mounting through hole 41 of the first panel member 4. Further, a reflow soldering can be employed with the use of a solder paste to bond the mounting base member 1 to the first panel member 4.

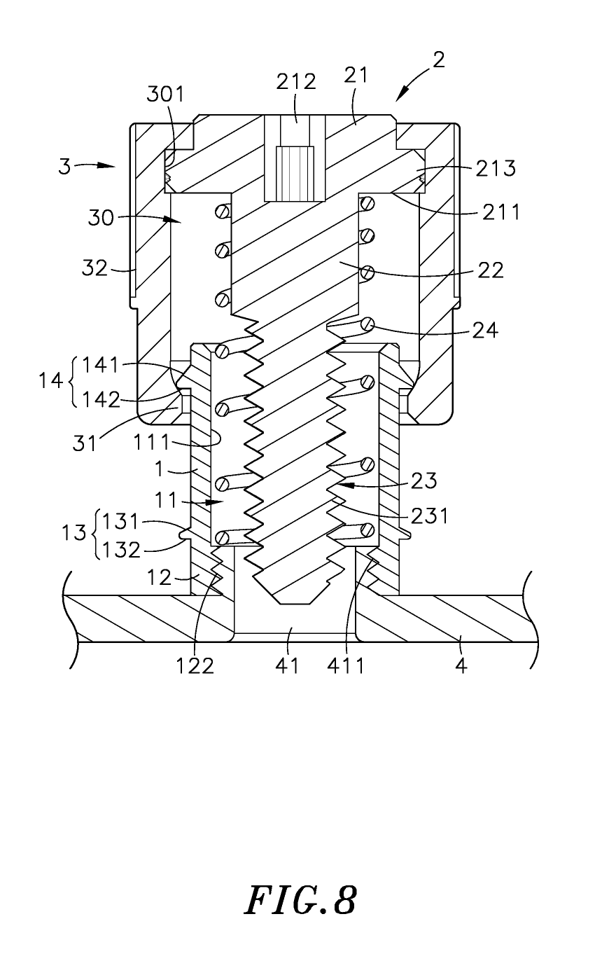

Further, a screw joint can be used to fasten the mounting base member 1 of the floating fastener to the mounting through hole 41 of the first panel member 4 instead of the technique of riveting or soldering. In an alternate form of the present invention, as shown in FIG. 8, the mounting base member 1 eliminates the aforesaid bottom mounting neck 12 and comprises an inner thread 122 in the bottom side thereof for threading onto an outer thread 411 at the top side of the first panel member 4 around the mounting through hole 41.

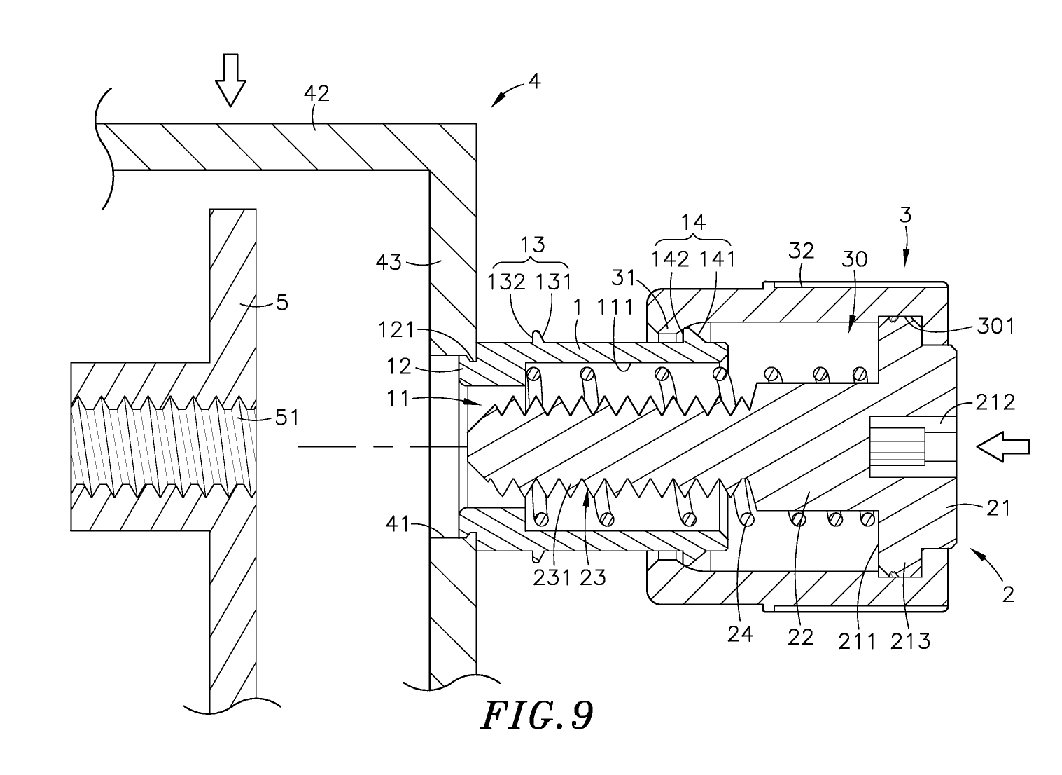

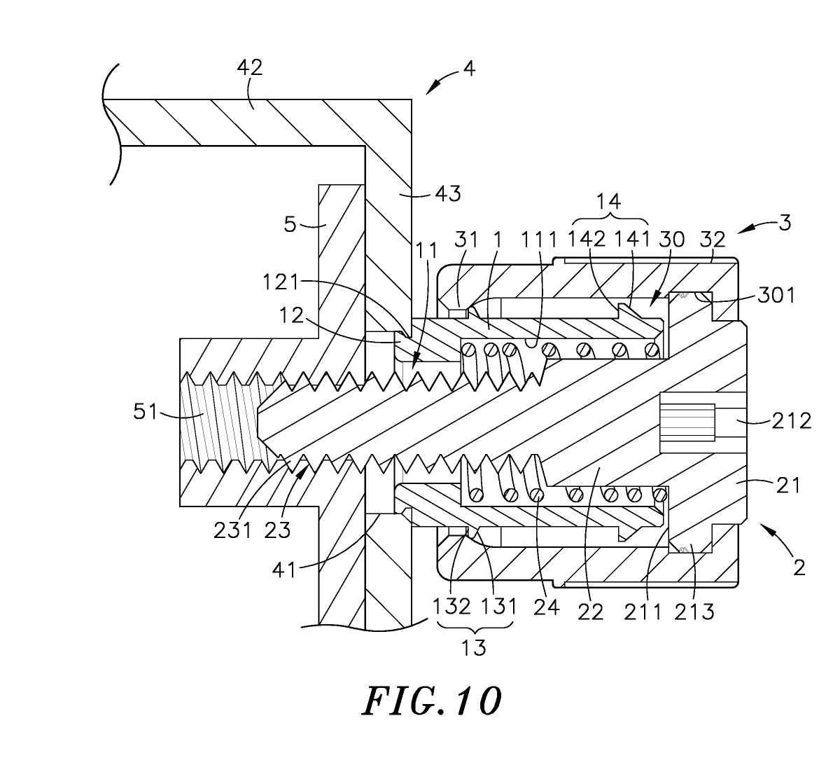

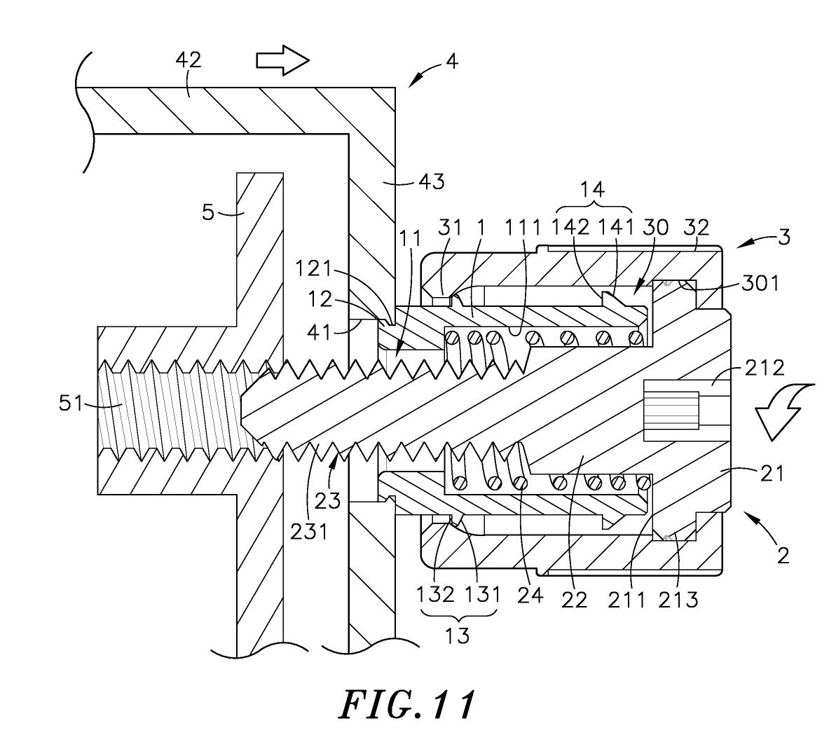

Referring to FIGS. 9-11, the aforesaid first panel member 4 is an angled panel having a horizontal panel portion 42 and a vertical panel portion 43, wherein the mounting through hole 41 is located at the vertical panel portion 43. When fastening the first panel member 4 to the second panel member 5, cover the horizontal portion 43 of the first panel member 4 on the second panel member 5 to keep the mounting through hole 41 in axial alignment with a mounting screw hole 51 in the second panel member 5. At this time, the inside bottom stop flange 31 of the cap member 3 is coupled to the periphery of the mounting base member 1 and axially slidable relative to the mounting base member 1 between the lower locating flange 13 and upper locating flange 14. Subject to the elastic potential energy of the compression spring 24, the rotary fastening member 2 is supported in such a position where the screw rod 23 is received inside the through hole 11 of the mounting base member 1. This, when covering the first panel member 4 on the second panel member 5, the rotary fastening member 2 is prohibited from touching the second panel member 5, avoiding damage.

After the vertical panel portion 43 of the first panel member 4 is closely attached to the surface of the second panel member 5 to keep the mounting through hole 41 in accurate alignment with the mounting screw hole 51, force the head 21 of the rotary fastening member 2 and the cap member 3 in direction toward the second panel member 5 to insert the tip of the screw rod 23 of the rotary fastening member 2 into the mounting screw hole 51, and then rotate the cap member 3 and the rotary fastening member 2 to thread the spiral outer thread 231 of the screw rod 23 into the mounting screw hole 51, and then use a power hand tool, or a hand tool (screwdriver or wrench) to fasten tight the rotary fastening member 2. Because the mounting base member 1 is fixedly fastened to the first panel member 4 and the rotary fastening member 2 is supported on the compression spring 24 in the mounting base member 1, the screw rod 23 of the rotary fastening member 2 can accurately fastened to the mounting screw hole 51 of the second panel member 5, avoiding thread damage.

When fastening the spiral outer thread 231 of the screw rod 23 of the rotary fastening member 2 into the mounting screw hole 51 of the second panel member 5, the inside bottom stop flange 31 of the cap member 3 can be moved over the sloping guide surface 131 of the lower locating flange 13 to the space around the periphery of the mounting base member 1 between the bottom stop surface 132 of the lower locating flange 13 and the vertical panel portion 43 of the first panel member 4. Thus, the lower locating flange 13 of the mounting base member 1 can stop the inside bottom stop flange 31 of the cap member 3 to prevent backward rotation of the screw rod 23 relative to the mounting screw hole 51 of the second panel member 5.

When going to remove the first panel member 4 from the second panel member 5, operate the grip 32 of the cap member 3 to rotate the cap member 3 and the rotary fastening member 2 in the reversed direction, thereby disengaging the screw rod 23 of the rotary fastening member 2 from the mounting screw hole 51 of the second panel member 5. During rotation of the rotary fastening member 2 in direction away from the mounting screw hole 51 of the second panel member 5, the inside bottom stop flange 31 of the cap member 3 is kept stopped at the bottom stop surface 132 of the lower locating flange 13 of the mounting base member 1 to prohibit the screw rod 23 from moving back to the inside of the through hole 11 of the mounting base member 1. Thus, after disengagement between the screw rod 23 of the rotary fastening member 2 and the mounting screw hole 51 of the second panel member 5, the floating fastener and the first panel member 4 can be directly separated from the second panel member 5. Thus, using the floating fastener enables the first panel member 4 to be fastened to or separated from the second panel member 5 conveniently with less effort.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A floating fastener installed in a mounting through hole of a first panel member and adapted for detachably locking said first panel member to a mounting screw hole of a second panel member, the floating fastener comprising:
a mounting base member comprising opposing top side and bottom side, a through hole vertically extending through said opposing top and bottom sides, a bottom mounting neck downwardly extended from said bottom side around said through hole and affixed to said first panel member, and a lower locating flange extending around the periphery thereof adjacent to said bottom mounting neck;
a rotary fastening member axially movably mounted in said mounting base member, said rotary fastening member comprising a head suspending above said mounting base member, a shoulder perpendicularly downwardly extended from a flat bottom wall of said head and a screw rod axially forwardly extended from said shoulder in a concentric manner and adapted for threading into said mounting screw hole of said second panel member;
an elastic member mounted around said shoulder of said rotary fastening member and stopped between said flat bottom wall of said head of said rotary fastening member and a part inside said mounting base member; and
a cap member affixed to said head of said rotary fastening member, said cap member comprising an accommodation open space surrounded by an inside wall thereof and extending through opposing top and bottom sides thereof for accommodating said mounting base member and said rotary fastening member, and an inside bottom stop flange extended around the inside wall of said cap member at a bottom side of the accommodation open space and axially slidably coupled to the periphery of said mounting base member and elastically deformably movable in direction from the top side of said mounting base member toward the bottom side of said mounting base member over said lower locating flange and then stoppable at a bottom side of said lower locating flange.

2. The floating fastener as claimed in claim 1, wherein said mounting base member further comprises a recessed accommodation chamber defined in the top side thereof in communication with the through hole of said mounting base member; said elastic member is a compression spring mounted around said shoulder of said rotary fastening member and stopped between said flat bottom wall of said head of said rotary fastening member and a bottom wall of said recessed accommodation chamber.

3. The floating fastener as claimed in claim 1, wherein mounting base member further comprises a mounting groove extending around the periphery of said bottom mounting neck.

4. The floating fastener as claimed in claim 1, wherein mounting base member further comprises an inner thread spirally extending around an inside wall of said bottom mounting neck and threaded onto an outer thread at said first panel member above said mounting through hole.

5. The floating fastener as claimed in claim 1, wherein said lower locating flange of said mounting base member defines a sloping guide surface at a top side thereof, and a bottom stop surface at a bottom side thereof.

6. The floating fastener as claimed in claim 1, wherein said mounting base member further comprises an upper locating flange extending around the periphery near the top side thereof, said upper locating flange defining a sloping thrust surface at a top side thereof, and a bottom abutment surface at a bottom side thereof.

7. The floating fastener as claimed in claim 6, wherein said upper locating flange is relatively larger in diameter than said lower locating flange.

8. The floating fastener as claimed in claim 1, wherein said rotary fastening member further comprises a tool-positioning means located at a top side of said head made in one of the forms of straight slot, crossed slot, star shaped slot, hexagonal slot, straight block, crossed block, star shaped block and hexagonal block, and an engagement portion extending around the periphery of said head; said cap member further comprises an inside locating groove extending around the inside wall near the top side thereof for engagement with said engagement portion of said rotary fastening member, and a grip extended from the periphery thereof and selectively made in the form of a series of longitudinal teeth, an embossed pattern or an array of raised portions.

9. The floating fastener as claimed in claim 1, wherein said cap member is a plastic member molded on said head of said rotary fastening member by insert molding.

10. The floating fastener as claimed in claim 1, wherein said rotary fastening member further comprises an outer thread spirally extending around the periphery of said screw rod.
